(19) United States
(12) Patent Application Publication
(10) Pub. No.: US 2014/0150515 A1
(43) Pub. Date: Jun. 5, 2014

(54) Horizontal Type Slitting Apparatus For Decladding of a Fuel Rod

(71) Applicants: Korea Hydro & Nuclear Power Co., Ltd., Seoul (KR); Korea Atomic Energy Research Institute, Daejeon (KR)

(72) Inventors: Kwang Hun CHO, Republic of Korea (KR); Geun PARK, II, Republic of Korea (KR); Jae Won LEE, Daejeon (KR); Young Hwan KIM, Daejeon (KR); Young Soon LEE, Daejeon (KR); Do Youn LEE, Daejeon (KR); Han Soo LEE, Daejeon (KR)

(73) Assignees: Korea Hydro & Nuclear Power Co., Ltd., Seoul (KR); Korea Atomic Energy Research Institute, Daejeon (KR)

(21) Appl. No.: 14/089,977

(22) Filed: Nov. 26, 2013

(30) Foreign Application Priority Data
Nov. 30, 2012 (KR) 10 2012 0137781

(51) Int. Cl. G21C 19/37

(52) U.S. Cl. CPC G21C 19/37
USPC 72/255

(57) ABSTRACT

A horizontal type slitting apparatus for decladding of a fuel rod is disclosed. The apparatus optionally includes a plurality of rollers configured to receive, extrude, and transfer a fuel rod, a roller fixing portion configured to fix the rollers by a hydraulic pressure, a slitting portion configured to slit cladding tube of the fuel rod, and a slitter fixing portion configured to fix the slitter portion by a hydraulic pressure.

### CROSS-REFERENCE TO RELATED APPLICATION

This application claims the benefit of Korean Patent Application No. 10-2012-0137781, filed on Nov. 30, 2012, in the Korean Intellectual Property Office, the disclosure of which is incorporated herein by reference.

### BACKGROUND

1. Field of the Invention

The present invention relates to a decladding apparatus for separating and recovering fuel materials and cladding tube by horizontally slitting the cladding tube of a fuel rod and a defective unirradiated fuel rod.

2. Description of the Related Art

Fuel rods are manufactured in a variety of sizes of a cladding tube, such as several meters of length, and several millimeters to tens of millimeters of an outer diameter and about one millimeter of a thickness or less, respectively. In the following, a fuel rod refers to a cladding tube charged with fuel materials.

In a nuclear reactor, heat is generated by nuclear fission of nuclear materials in uranium dioxide (UO₂) pellets. The heat is transferred to coolant water through the cladding tube. Due to extremely low thermal conductivity of UO₂, a great temperature gradient of about 100° C./mm is generated in the UO₂ pellets. While first power is increased, the pellets are cracked due to the difference of thermal expansion coefficient along their radius.

For example, a spent nuclear fuel may be a nuclear fuel rod. After fission of the nuclear fuel in the reactor, the cladding tube of a spent nuclear fuel rod may become uneven by being distorted or swollen due to high pressure and high temperature and fission gases, resulting in a defective nuclear fuel rod.

When a nuclear fuel rod is determined to be defective or spent, the cladding tube and the UO₂ pellets are typically separated for recycling of the cladding tube—a processwhich is relatively expensive.

For recycling of the spent nuclear fuel, recovery of fuel materials in the cladding tube is typically performed. Recycling of the cladding materials is generally performed in one of two ways: (1) by mechanical decladding, or by oxidative decladding. The mechanical decladding method is typically performed by cutting the fuel rod into various lengths according to an applied scheme. The oxidative decladding method needs to cut the fuel rod into very short lengths, such as tens of millimeters.

The apparatus according to an embodiment of the present invention relates to a system and method of mechanical decladding technology, including slitting, hammering, and stirring after hammering, roll-straightening and the like. For decladding by the hammering and the stirring after hammering, the cut fuel rods are typically cut into short lengths. Conversely, decladding through the use of a roll straighter, the fuel rods typically cut relatively long. However, one end of the fuel rod is typically cut and hammered after the roll-straightening to recover the fuel materials.

A slitting apparatus is often used for recovering the fuel materials in the form of fuel particles by slitting the cladding tube. The slitting apparatus may be developed in a vertical type or a horizontal type according to a direction of laying the fuel rod to be cut.

In a conventional slitting apparatus, a unit for slitting the cladding tube may include cutting blades for slitting and rollers for guiding extrusion of the cladding tube. The cutting blades and the rollers of the slitting assembly are typically configured such that the rollers are disposed between the respective neighboring cutting blades at intervals of about 120 degrees in a circumferential direction.

Slitting intervals of fuel rods having different diameters may be controlled by adding or removing a spacing plate between the cutting blade and a ranch bolt for fixing the slitting blade to the slitting assembly. Alternatively, replacement of the slitting assembly is necessary. When the fuel rod is partially bent or swollen, the fuel rod may damage the cutting blades or may be jammed in the slitting assembly.

Accordingly, a conventional slitting apparatus that transfers the fuel rod into the slitting assembly using a push rod needs to be doubled in length. To reduce the length of the apparatus, the fuel rod is to be further cut corresponding to the length of the apparatus. Also, a container for continuously supplying the fuel rod-cuts to the slitting assembly is necessary.

### SUMMARY

An aspect of the present invention provides a slitting apparatus for decladding of a fuel rod, capable of stably slitting a cladding tube of the fuel rod without damaging a cutting blade.

Another aspect of the present invention provides a slitting apparatus widely applicable to fuel rods in various lengths, including a cladding tube of various thicknesses.

Still another aspect of the present invention provides a slitting apparatus capable of completely slitting a cladding tube, by straightening a spent fuel rod being in a bent or swollen state so that the spent fuel rod is aligned with the cutting blade.

Yet another aspect of the present invention provides a slitting apparatus capable of slitting fuel rods in various diameters.

Further another aspect of the present invention provides a slitting apparatus capable of continuously processing a fuel rod having a length of one or more or several meters, by removing only a cap from each of the opposite ends of the fuel rod.

According to an aspect of the present invention, there is provided a horizontal type slitting apparatus for decladding of a fuel rod, the apparatus including a plurality of rollers configured to receive, extrude, and transfer a fuel rod, a roller fixing portion configured to fix the rollers by a hydraulic pressure, a slitting portion configured to slit cladding tube of the fuel rod, and a slitter fixing portion configured to fix the slitting portion by a hydraulic pressure.

The roller fixing portion may include a plurality of pairs of facing rollers, and a distance between each pair of the facing rollers is adjusted by controlling the hydraulic pressure of the roller fixing portion. The slitting portion may be disposed at an end of the plurality of rollers, and the distance between each pair of the facing rollers in the roller fixing portion may be reduced in a direction toward the slitting portion.

In detail, the rollers are arranged in two rows facing each other. The rollers receive to and transfer fuel rods by extrusion. Specifically, a roller arranged at a first end receives fuel rods of which upper and lower cap are removed. A plurality of other rollers may straighten the fuel rods in a bent or swollen state. A roller arranged at a final end transfer the fuel rods to the slitting portion. A force for straightening the fuel rods may be adjusted by controlling a pressure of hydraulic cylinders mounted to the roller fixing portion to face each other. The rollers arranged on one side may be fixed to the body portion and rotated in connection with a variable driving motor. A extrusion speed with respect to the fuel rods may be controlled by a pressure applied to the fuel rods and a rotational speed of the variable driving motor. The rollers of the opposite side may be automatically rotated due to driving force transferred from the fuel rods extruded by the rollers connected with the variable driving motor. Such an operation may be controlled by a pressure of a hydraulic cylinder disposed at the rollers.

Decladding of the fuel rods may be performed by rotation of two circular cutting blades inserted between the rollers arranged at upper and lower portion. Rotation of the cutting blades may be caused by the fuel rods being extruded from a plurality of rollers. A force for cutting the fuel rods may be adjusted by controlling a pressure of hydraulic cylinders mounted at upper and lower portion of the rollers.

Forces applied to a plurality of rollers and the rollers of the slitting portion may be generated by the hydraulic cylinder. The hydraulic pressure may be controlled by a first hydraulic pressure controller and a second hydraulic pressure controller.

### EFFECT

According to embodiments of the present invention, continuous slitting of a fuel rod is possible by removing only the upper and lower end cap of the fuel rod. Therefore, processing quantity is increased over prior systems, and an installation space for an apparatus is reduced.

According to embodiments of the present invention, the apparatus is optionally to applied to fuel rods in various diameters and lengths including cladding tube of various thicknesses found in the art.

Additionally, according to embodiments of the present invention, the apparatus is optionally arranged such that it straightens a spent fuel rod being in a bent or swollen state without an additional preprocessing, thereby eliminating the need for an additional device.

Additionally, according to embodiments of the present invention, a cladding tube of the fuel rod is stably slit without damaging a cutting blade.

Furthermore, according to embodiments of the present invention, the apparatus is applicable even to a defective non-irradiated fuel rod.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a front view illustrating a slitting apparatus for decladding of a fuel rod, according to an embodiment of the present invention;

FIG. 2 is a side view illustrating the slitting apparatus for decladding of a fuel rod; and

FIG. 3 is a front view illustrating a slitting portion and a partially enlarged view illustrating a slitter fixing portion.

### DETAILED DESCRIPTION

Reference will now be made in detail to exemplary embodiments of the present invention, examples of which are illustrated in the accompanying drawings, wherein like reference numerals refer to the like elements throughout. The scope of the invention is not limited to the exemplary embodiment(s) but may be suggested in different manners through addition, modification, and deletion of the components, where the following modifications and the like are also included in the scope of the invention.

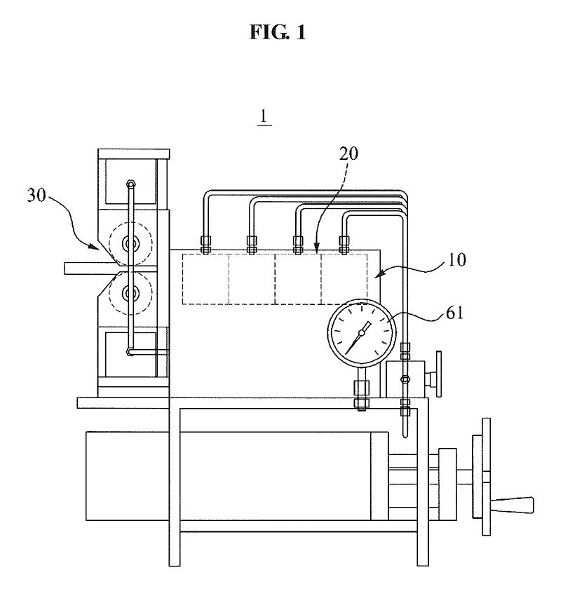

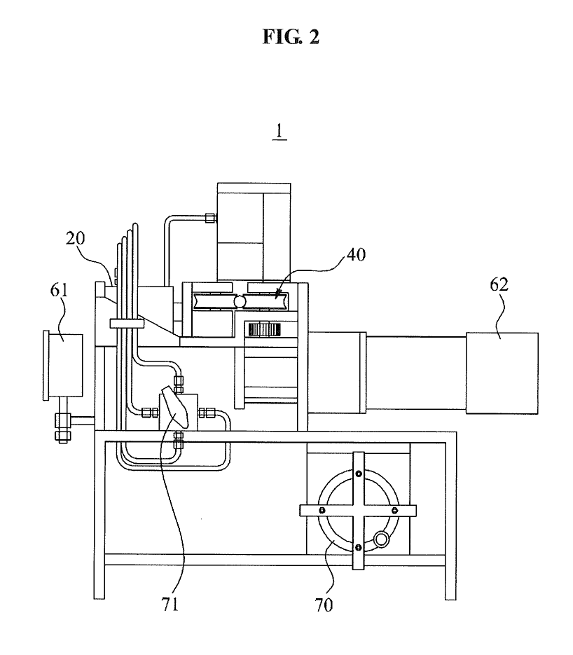

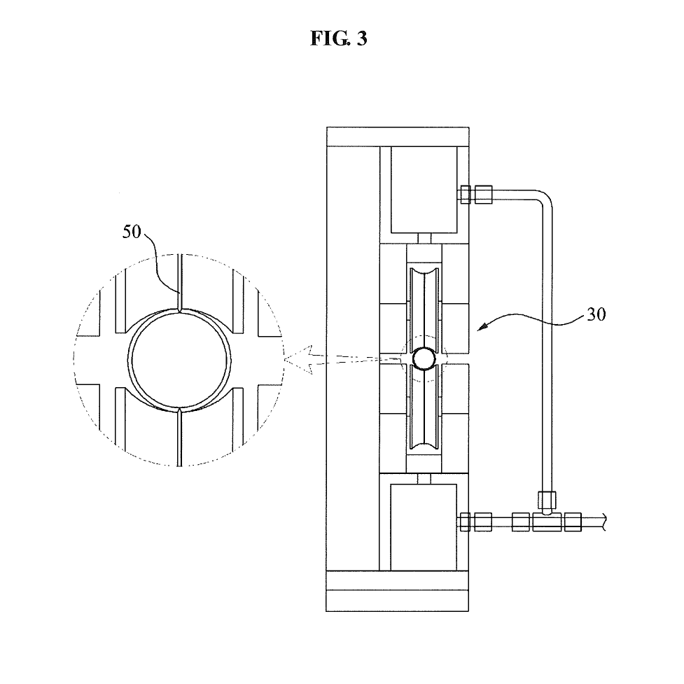

FIG. 1 is a front view illustrating a slitting apparatus 1 for decladding of a fuel rod, according to an embodiment of the present invention. FIG. 2 is a side view illustrating the slitting apparatus 1 for decladding of a fuel rod. FIG. 3 is a front view illustrating a slitting portion and a partially enlarged view illustrating a slitter fixing portion.

Referring to FIGS. 1 to 3, the slitting apparatus 1 includes a body portion 10, a roller 40, a roller fixing portion 20, a slitting portion 50, and a slitter fixing portion 30.

The body portion 10 forms the appearance of the slitting apparatus 1, while supporting the roller 40, the roller fixing portion 20, the slitting portion 50, and the slitter fixing portion 30. The body portion 10 may be separated by a predetermined distance from a ground surface and may be provided substantially cylindrical in shape.

The roller 40 may be plural in number and rotatably mounted to the body portion 10. The roller 40 may include a plurality of facing rollers. A fuel rod is inserted between each pair of the facing rollers 40. The rollers 40 rotate in contact with the fuel rod, thereby transferring the fuel rod in a predetermined direction.

The rollers 40 may be rotated by a driving motor 62. The driving motor 62 may be disposed at one side of the body portion 10 and may transmit a rotational force of the driving motor 62 to the rollers 40 through a gear. For example, a helical gear may be provided to a rotational shaft of the driving motor 62. The helical gear may thereby rotate rollers 40.

Optionally, rotational shafts of rollers 40 may each include a pinion gear so that the plurality of rollers 40 are geared with each other. When any one of the plurality of rollers 40 is rotated by the driving motor 62, remaining rollers may be similarly rotated at a similar rate.

Further optionally, roller 40 is fixed or moved by roller fixing portion 20. Roller fixing portion 20 is optionally connected to a side of the roller 40 to prevent the roller 40 to from being pushed to the side during transfer of the spent fuel rod. Further optionally, roller fixing portion 20 may be provided in a tetrahedral shape and provided for each of rollers 40.

According to another embodiment, roller fixing portion 20 may fix roller 40 by applying a hydraulic pressure to roller 40. A hydraulic pressure generation portion (not shown) may be provided in the body portion 10 to supply the hydraulic pressure to roller fixing portion 20. The hydraulic pressure generated from the hydraulic pressure generation portion may be transmitted to the roller fixing portion 20 through a hydraulic fitting as known in the art.

A distance between the facing rollers 40 may be adjusted by controlling the hydraulic pressure of the roller fixing portion 20. For example, a distance between a particular pair of rollers 40 may be reduced by increasing the hydraulic pressure provided by a roller fixing portion 20 connected to the particular pair. Also, the distance between the particular pair of rollers 40 may be increased by reducing the hydraulic pressure provided by the roller fixing portion 20 connected to the particular pair.

The distance between the facing rollers 40 may be reduced in a direction toward the slitting portion 50. The slitting portion 50 may be disposed at an end of the plurality of rollers 40. Since a relatively great pressure is applied to the fuel rod when the fuel rod is cut by the slitting portion 50, the distance between the opposing facing rollers 40 may be reduced in the direction toward the slitting portion 50 to ensure solid contact between the fuel rod and a face of rollers 40 is secured close to slitting portion 50. Roller fixing portion 20 may apply a greater hydraulic pressure to a roller 40 disposed nearer to the slitting portion 50.

A hydraulic pressure indicator 61 for indicating the hydraulic pressure operated at the roller fixing portion 20 may be disposed at one side of the body portion 10. The hydraulic pressure indicator 61 may be a gauge board including numerical values or a needle. A user may control the hydraulic pressure applied to the rollers 40 from roller fixing portion 20 by checking the hydraulic pressure through the hydraulic pressure indicator 61.

In addition, a roller hydraulic pressure controller 71 may be provided at one side of the body portion 10 to control the hydraulic pressure of the roller fixing portion 20. The roller hydraulic pressure controller 71 may control the hydraulic pressure generated from the hydraulic pressure generation portion and transmit the controlled hydraulic pressure to the roller fixing portion 20. The roller hydraulic pressure controller 71 may include a handle for the user to rotate to control the hydraulic pressure.

The slitting portion 50 may be disposed at an end of the body portion 10, that is, an end of the arrangement of the plurality of rollers 40. The slitting portion 50 may include circular cutting blades facing each other. The fuel rod may be inserted between the facing cutting blades. As the cutting blades rotate, cladding tube of the fuel rod may be slit and separated.

The slitter fixing portion 30 may be provided to the slitting portion 50. The slitter fixing portion 30 may fix the slitting portion 50 by applying the hydraulic pressure to the slitting portion 50. The hydraulic pressure generation portion may provide the hydraulic pressure to not only the roller fixing portion 20 but also the slitter fixing portion 30.

In addition, the slitting hydraulic pressure control portion 70 may be provided at one side of the body portion 10 to control the hydraulic pressure provided to the slitter fixing portion 30. The user may control the hydraulic pressure provided to the slitter fixing portion 30 by manipulating the slitting hydraulic pressure control portion 70. The slitting hydraulic pressure control portion 70 may include a handle so that the user may control the hydraulic pressure by rotating the handle.

According to a conventional art, since decladding is performed using a slitting assembly, when fuel rods have different diameters, control of a distance between cutting blades or replacement of the slitting assembly is necessary. Also, one fuel rod needs to be cut into several pieces for decladding. However, according to the embodiment of the present invention, a distance between rollers of a roller fixing portion is controlled by a to hydraulic cylinder to receive fuel rods having different diameters. In addition, a distance between cutting blades of a slitter fixing portion may be controlled by a hydraulic cylinder. Therefore, the fuel rods having different diameters may be continuously slit by cutting only upper and lower end cap.

According to the conventional art, since the slitting assembly is used, processing of a spent fuel rod which is bent or swollen is difficult. However, according to the embodiment of the present invention, the bent or swollen spent fuel rod may be straightened using rollers and therefore slitting of the spent fuel rod is facilitated with reduced difficulty.

The conventional decladding of the fuel rod may damage the cutting blades. However, according to the embodiment of the present invention, the cutting blades may be fixed using a hydraulic pressure. Therefore, the fuel rod may be stably cut without causing damage to the cutting blades.

Although the embodiment of the present invention has been described with respect to a spent fuel rod, the present invention is not limited to the spent fuel rod but may be applied to various types of fuel rod including an unirradiated defective fuel rod.

What is claimed is:

1. A horizontal type slitting apparatus for decladding of a fuel rod, the apparatus comprising:
a plurality of rollers configured to receive, extrude, and transfer a fuel rod;
a roller fixing portion configured to establish the position of the rollers by a hydraulic pressure;
a slitting portion configured to slit cladding from the fuel rod; and
a slitter fixing portion configured to adjust and/or fix the slitting portion by a hydraulic pressure.

2. The horizontal type slitting apparatus of claim 1, wherein the roller fixing portion comprises a plurality of pairs of facing rollers, wherein thedistance between each pair of the facing rollers is adjusted by controlling the hydraulic pressure of the roller fixing portion.

3. The horizontal type slitting apparatus of claim 2, wherein
the slitting portion is disposed at an end of the plurality of rollers distal to a fuel rod intake area, and
wherein the distance between each pair of the facing rollers in the roller fixing portion is reduced in a direction toward the slitting portion.

4. The horizontal type slitting apparatus of claim 1, wherein cutting blades are inserted into the rollers of the slitting portion to control a distance between the rollers facing each other by a hydraulic pressure.

5. The horizontal type slitting apparatus of claim 1, wherein the slitting portion comprises circular cutting blades facing each other.

6. The horizontal type slitting apparatus of claim 1, wherein at least one of the roller fixing portion and the slitter fixing portion comprises a hydraulic pressure indicator that indicates a hydraulic pressure when the apparatus is in use.

7. The horizontal type slitting apparatus of claim 1, wherein the fuel rod is a spent fuel rod.
